(19) United States
(12) Patent Application Publication
(10) Pub. No.: US 2007/0192070 A1
(43) Pub. Date: Aug. 16, 2007

(54) IMAGING SYSTEM AND METHOD FOR DETERMINING FALLING CURVES

(76) Inventor: Judson Chiu, North York (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(21) Appl. No.: 11/673,924

(22) Filed: Feb. 12, 2007

Related U.S. Application Data
(60) Provisional application No. 60/773,660, filed on Feb. 16, 2006.

(51) Int. Cl. G06F 17/10

(52) U.S. Cl. 703/2

(57) ABSTRACT

A system and method are provided for determining the trajectory or falling curves of charge material, particularly charge material distributed in a blast furnace. A video is acquired of the charge as it leaves the chute of the charging equipment at various ring positions. The video is converted to still images that are analyzed to obtain calibration and correction factors. These factors can then be used to extract and calibrate a model for the charging program to vary and control the distribution of charge in a vessel.

### CROSS REFERENCE TO RELATED APPLICATIONS

This application claims priority from U.S. application No. 60/773,660 filed on Feb. 16, 2006 which is hereby incorporated by reference.

### FIELD OF THE INVENTION

The present invention relates to imaging systems and has particular utility in determining the trajectory of charge material distributed in a vessel.

### DESCRIPTION OF THE PRIOR ART

A blast furnace is a structure used in the steel making process to produce molten liquid iron, also referred to as hot metal. A blast furnace is a generally cylindrical structure, however, its diameter and shape changes at different elevations. The furnace has an outside shell that is made from thick steel plate, and an inside shell that is lined with refractory. The refractory lining is typically cooled by water-cooled metal components called staves.

The production of hot liquid iron using a blast furnace begins by charging iron ore (typically in the form of pellets, sinter or lump), coke and flux (typically limestone) into the top of the furnace. These raw materials slowly descend to the lower part of the furnace, and, near the bottom of the furnace, super heated air (also referred to as a hot blast) is blown into the furnace. The hot blast causes the coke to burn at a very high temperature, and at the same time, a chemical change (typically called reduction) takes place, which produces pure molten iron and slag. The slag represents a combination of flux and the extracted impurities (typically SiO, MnO, S etc.) that exist in the charged iron ore and coke. The liquid products are removed from the furnace on a periodic basis. Slag and iron are separated using the difference in specific gravity between them. The iron also undergoes a process to remove sulphur content, and is then shipped to a steelmaking area for conversion into steel while slag runs into a pit for further processing.

A blast furnace includes a charging system for charging the iron ore, coke and flux at the beginning of the iron making process. The charging system includes two main areas, the stockhouse located a distance from the furnace, and the top charging equipment located at the top of the blast furnace. The function of the stockhouse system is to weigh, batch, and deliver a mixture of the raw materials (iron ore, coke and flux) to the top charging equipment. The top charging equipment serves to deliver and distribute the raw materials into the furnace body, through the furnace top.

In a typical example, weighed raw materials are gathered in a batch mode governed by a predefined charge process (also known as a charge program) at the stock-house, and are delivered to the top charging equipment either by a skip car or by a conveyor belt. The size of the blast furnace, productivity requirements, and the availability of space are considerations that are made when determining whether a skip car or conveyor belt are used. The raw materials are then distributed into the furnace by the top charging equipment, which is also controlled by the charge program.

Traditionally, the top charging equipment uses either a two-bell type top, or a bell-less type top (also referred to as a Paul Wurth top). A two-bell type top is generally constructed with a material distributor, a small bell, and a large bell. The lower edge of the upper face of the large bell forms a seal against the bottom edge of a large bell hopper. Similarly, the small bell forms a seal against the bottom edge of a small bell hopper connected to the material distributor. The bells are connected by a rod that moves in a vertical direction. Raw material is first delivered to the small bell hopper by, e.g. a skip car. With the large bell closed, the small bell is lowered and the charge material in the small bell hopper is dropped onto the large bell. This is repeated while maintaining the seal of the large bell. The small bell is then sealed and the large bell is lowered to distribute material into the furnace without allowing any pressurized process gases to escape. Using this process, the large bell, the small bell, and the large bell hopper are subjected to heavy impact and severe abrasion, particularly at the bell sealing interfaces.

Improved two-bell hoppers have been developed, however, recently, the bell-less top has typically been favoured. The bell-less top was developed to address the problem of gas sealing under a high-pressure operation, to provide flexibility, and to reduce maintenance.

In operation, one or more lockhoppers are filled with raw material using the stockhouse system. The lockhoppers are then sealed and pressurized to the operating pressure of the furnace top. Each lockhopper is equipped with an upper and lower seal valve and a material flow control gate. The lockhoppers are used alternately, such that one is being filled while another is being emptied. By design, in order to reduce the likelihood of a sealing problem the seal valves are typically placed out of the path of material flow, which inhibits material abrasion. The flow control gate then opens to a predetermined position, which will vary based on the type of raw material whose flow it is controlling. The lower seal valves and flow control gates are in a common gas-tight housing and feed a material flow chute. The chute is used to direct material into the furnace.

When the level of material in the furnace (also referred to as the stockline) has descended to a particular level, the lower seal valve opens and allows charge to flow at a controlled rate to the chute. The chute rotates about a central vertical axis of the furnace and can adjust its angle relative to that axis, to any one of a number of predetermined positions. Each position provides a different “ring” of material within the furnace. The system used to control the chute has the flexibility of charging the material in distinctive rings, in spiralling rings of increasingly smaller diameter, or of point/spot area filling. Moreover, the quantity of material in each discharge area can be controlled if desired.

Typically, for efficient blast furnace operation, the raw materials should be charged into the furnace in a particular distribution. To predict how the charge material is distributed, e.g. by the chute, a mathematical model is used that determines the theoretical profile of the build-up of the material as it lands in the furnace. An important component for calibrating such a mathematical model is measuring the falling curves of the material, i.e., the trajectory of the material as it leaves the chute and travels to its resting place.

Traditionally, falling curves have been measured using various methods. These methods include installing a beam within the furnace that extends about half way across the furnace diameter, and having a series of bins spaced along the beam. The bins collect charge material as it falls, and the distribution within the bins is used to infer the trajectory of the charge. This approach is generally inaccurate since the trajectory is indirectly measured from the weight of the material in each bin.

Another approach, shown in Canadian Patent Application No. 2,383,538 to Danloy et al., involves installing a cantilevered probe within the furnace that senses impact from falling material. The deflection of the probe is used to determine the trajectory. This method also tends to be inaccurate since it uses an indirect measurement.

Yet another approach involves viewing the falling material with a camera, against a grid structure built inside the furnace. The grid is used to correlate the camera pixel positions to real distances. The structure is typically made of steel mesh that has a width that is approximately half the furnace diameter and is carefully mounted so as to span between the furnace center and its wall. Preferably, the mesh should be mounted to be perpendicular to the camera in order to obtain an accurate measurement. Although this approach directly measures the trajectory, its accuracy is limited since the method depends on the size of the grid and the accuracy of the installation. Moreover, the installation of the grid itself can be time consuming, and costly.

A method and apparatus for measuring the trajectory of charge material being distributed into a vessel or kiln such as the shell of a blast furnace is needed that has improved accuracy and is simpler to implement than the methods described above.

It is therefore an object of the present invention to obviate or mitigate the above-identified disadvantages.

### SUMMARY OF THE INVENTION

In one aspect a method for calibrating a model representing the distribution of material into a vessel is provided. The method comprising the steps of acquiring an image of the material at a predetermined distribution position; determining a correlation between a pixel in the image and a unit of distance from an object in the image having a known dimension; determining from the image, a portion thereof representing the material; and using the correlation and the portion to obtain at least one parameter indicative of the nature of the distribution for calibrating the model.

In another aspect, a system is provided for calibrating a model representing the distribution of material into a vessel. The system comprises an imaging system for acquiring an image of the charge material at a predetermined distribution position; a light source to illuminate the charge material for obtaining the image; a processor in communication with the imaging system for determining a correlation between a pixel in the image and a unit of distance from an object in the image having a known dimension and for determining from the image a portion thereof representing the material and using the correlation and the portion to obtain at least one parameter indicative of the nature of the distribution; and an output comprising the at least one parameter, wherein the output may be used to calibrate the model.

### BRIEF DESCRIPTION OF THE DRAWINGS

An embodiment of the invention will now be described by way of example only with reference to the appended drawings wherein:

FIG. 1 shows an imaging system incorporated in a sectional view of the upper portion of a blast furnace;

FIG. 2 is a schematic drawing of the imaging system of FIG. 1;

FIG. 3 is a schematic drawing of the chute shown in FIG. 1;

FIG. 4 is an image acquired by the imaging system of FIG. 1;

FIG. 5 is a flow chart depicting a method for determining falling curves;

FIG. 6 shows a pixel to millimetre calibration operation; and

FIG. 7 shows a rotational correction operation.

FIG. 8 is a plan view showing the orientation of the camera of FIG. 2 with respect to vertical.

FIGS. 9 and 10 illustrate delta and velocity measurements.

FIG. 11 is a schematic showing the development of a charge program.

### DETAILED DESCRIPTION OF THE INVENTION

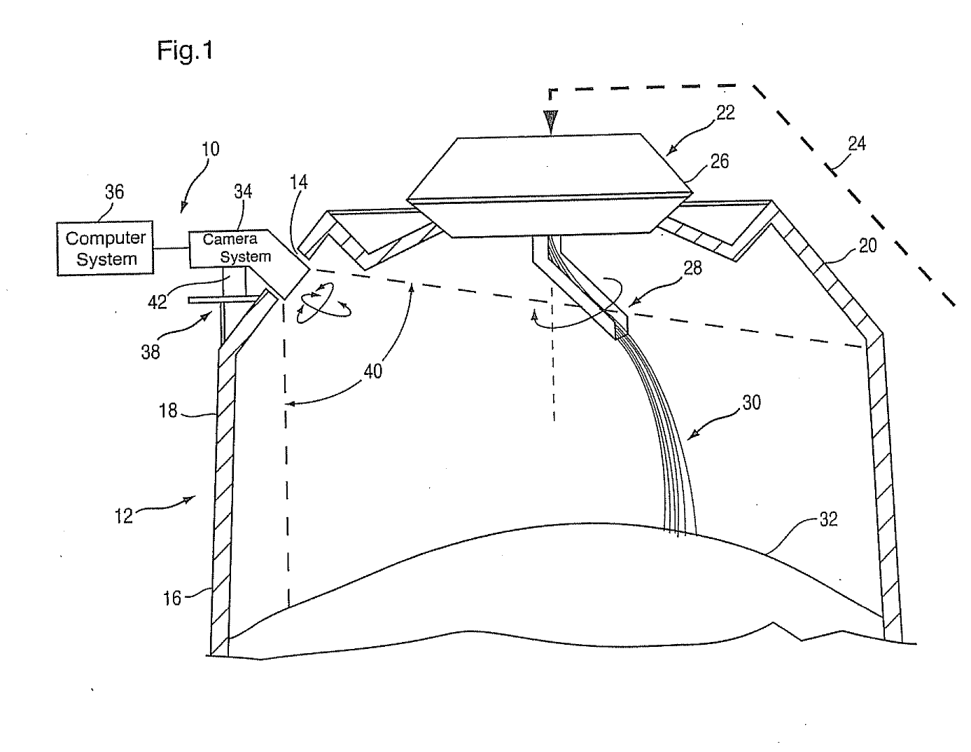

Referring therefore to FIG. 1, an imaging system for calibrating a furnace model by determining the trajectory of charge material into the furnace and generating furnace parameters based on the trajectory, is generally denoted by numeral 10. In the example shown in FIG. 1, the system 10 is arranged to view the interior of an inactive blast furnace 12 through a manhole 14, although, the system 10 is also applicable to other vessels and kilns that receive a charge of material. FIG. 1 shows the upper portion of the shell 16, the throat 18, and the top cone 20 of the blast furnace 12. The cone 20 supports the top charging equipment 22 that is delivered raw material from the stockhouse system (not shown) via path 24. The charging equipment 22 is generally comprised of a Paul-Wurth top 26 and a chute 28 connected thereto. The chute 28 delivers a stream of charge material 30 into the blast furnace 12, and the charge material 30 piles up within the shell 16, the upper extent of which defines a stockline 32.

The system 10 is generally comprised of a camera system 34, an off-camera processor or computer system 36, and a support stand 38. The camera system 34 is capable of adjusting both tilt and yaw, in order to control the orientation of its field-of-view (FOV) 40. Preferably, the FOV 40 should be able to capture an image that includes a portion of the chute 28, of portion of charge stream 30 and at least a portion of the shell 16 or throat 18. The camera system 34 may be adjusted using a flexible stand 42, or alternatively may employ a servomechanism (not shown) to adjust the position of its lens.

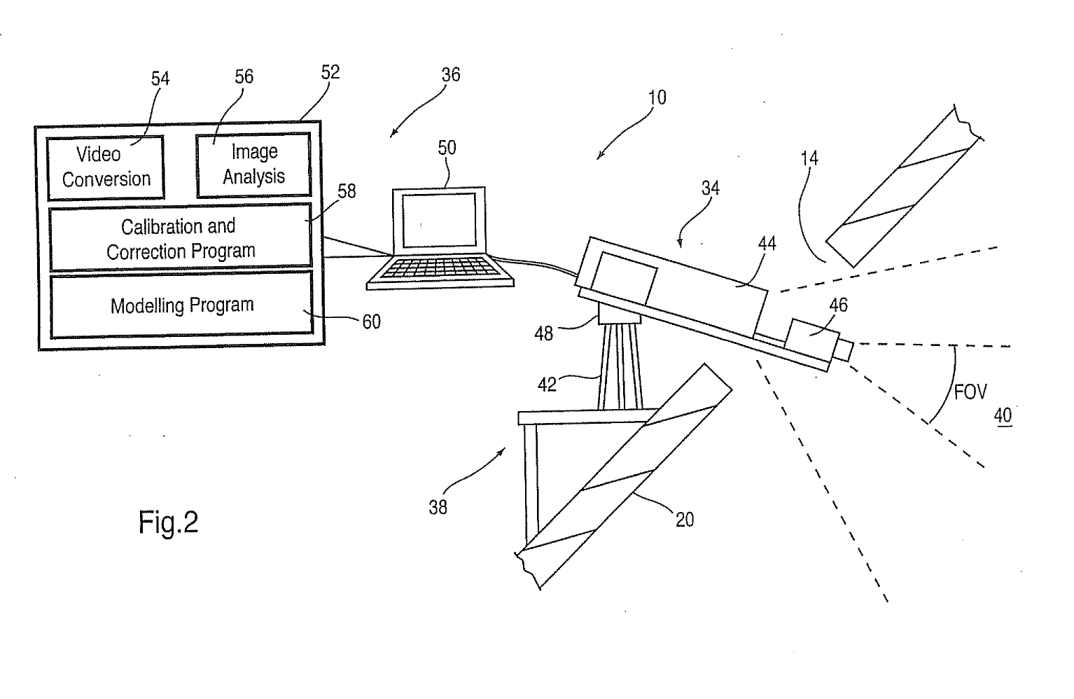

The system 10 is shown in greater detail in FIG. 2. The camera system 34 is generally comprised of the stand 42, a light 44 for illuminating the FOV 40, a camera 46 for acquiring images, and an adjustment mechanism 48 for adjusting the light 44 and camera 46. The adjustment mechanism 48 will typically adjust, for example the tilt and yaw of the light 44 and camera 46. However, it will be appreciated that the stand 42 may also require manual adjustment in the vertical direction and may require manual lateral adjustments atop the support 38 to accommodate variances in the movement of the chute 28, dimensions of the furnace 12, lighting, etc. The camera 46 is preferably a digital video recorder that is capable of acquiring both still digital photos as well as digital video. A suitable camera includes features such as greyscale 640×480 pixel resolution, E-Donpisha® shutter, progressive scan CCD, and 30 fps with a 2-mirrored coax output. The camera 46 may also be a “smart” camera that is itself capable of processing images, most preferably when the system 10 is used for constant curve validation on-line, during operation of the furnace. However, in the present example, the camera 46 is a conventional digital video recorder that can upload data to the computer system 36 for processing thereby, e.g. to perform charge program calibrations during a shutdown of the furnace 12.

The computer system 36 is generally comprised of a personal computer 50, having an internal software program 52 that includes various modules, a TV tuner such as MSI VOX USB2.0, and a suitable connection for communicating with camera 46. Preferably, the program 52 has at least a module for video conversion 54, a module for performing image analysis 56, a module for calibration and correction 58, and a modelling module 60. The program 52 may run directly on the computer 50 or may be accessed and run from a remote destination over a network (not shown).

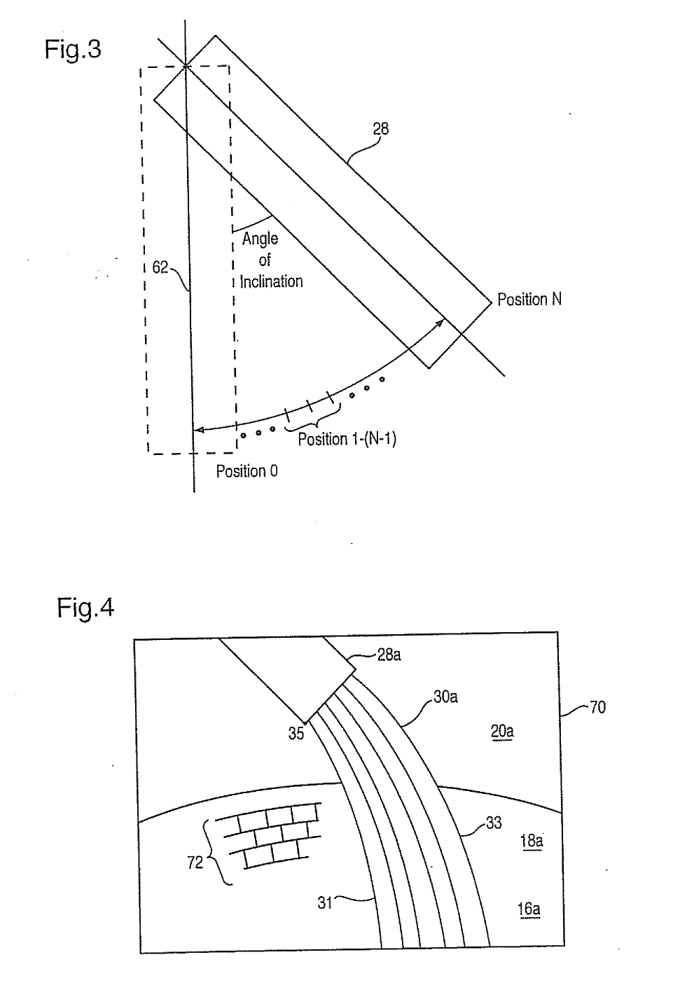

A schematic representation of the chute 28 is shown in FIG. 3. The chute 28 rotates about a vertical axis 62 and its angle of inclination with respect to the axis 62 can be adjusted to different ring positions. FIG. 3 shows an arbitrary N number of ring positions. The examples provided below will utilize ten (10) ring positions. It will be appreciated that the number of ring positions may vary depending on the application. Typically, at position zero (0) the mouth of the chute 28 is directed downwards along axis 62, and each successive position provides an adjustment of the angle of inclination by a predetermined amount. In a typical implementation, the final position (e.g. position 10) is at an angle of 47.2°, and each position between positions 0 and 10 provide angles of inclination between 0° and 47.2°. The intervals between successive positions may vary, but preferably, the positions are equally spaced within the range.

The camera 46 acquires a digital video of the chute 28 as it rotates within the furnace 12. The video is preferably a 640×480 pixel resolution, 24-bit, non-interlaced mpeg file that is compressed using an MPEG2 codec embedded in digital video recording software. The video may then be temporally segmented into a series of appropriate images such as image 70 shown in FIG. 4 by inputting a video file into conversion program 54. Digitized versions of the above components are given like numerals in FIG. 4, with the suffix “a” for consistency. An optimal image captures a stream of charge material 30 emerging from the mouth of the chute 28 when the longitudinal axis of the chute 28 is substantially perpendicular to the camera 46. The dimensions of the chute 28 are preferably known from pre-measurements and stored by the computer system 36 for later use as inputs to the calibration process. In FIG. 4, the charge stream 30a has an inner edge 31 and an outer edge 33. The alignment of the chute 28 with respect to the camera 46 may affect the spatial distortion of the image 70, and thus for optimal analysis, a substantially perpendicular alignment, as discussed above, is preferred in order to inhibit the need to correlate the image due to skewing or other effects. Since the images are preferably obtained from a video, the video may be analyzed in order to acquire the optimal image for making the necessary measurements in the image.

In order to identify, and distinguish between the components in the image 70, the image 70 is acquired while the scene within the furnace 12 is illuminated. The illumination is provided by the light 44. In one embodiment, the light 44 is a bright, standard incandescent lamp that is directed into the furnace as shown in FIG. 2 in order to illuminate the charge stream 30 and the chute 28. In this embodiment, it is desirable to have a light source that is as diffuse and uniform as possible in order to provide a clear image 70 of the stream 30a and chute 28a as shown in FIG. 4. In another embodiment, the light 44 is a laser generator, preferably a multi-line laser generator. The laser is preferably aimed at an angle to the stream 30, such that the laser line will look pronounced when the stream 30 passes through it.

Prior to performing calibration of the furnace parameters, the system 10 is assembled as shown in FIGS. 1 and 2, on platform 38, preferably using the flexible stand 42. The flexible stand 42 allows for the adjustment of tilt and yaw etc. and to orient the camera 46 and light 44 towards and through the opening 14. The stand 42 is adjusted with the intention of establishing a FOV 40 for the camera 46 that will include a portion of the chute 28 and as much of the illuminated stream 30 as possible in the subsequently acquired image 70 as shown in FIG. 4.

In a typical application, the stand 42 is adjusted such that the camera 46 is oriented at a downward 30° angle with respect to horizontal, and at a minimum of 15° with respect to the centreline 62, however more typically at an angle of 50+° with respect to centerline 62. Preferably, the camera 46 is oriented in a direction that allows the camera 46 to view the stream 30 prior to passing through the FOV 40 as shown in the schematic plan view of FIG. 8 (i.e. angle the camera 46 towards the approaching chute 28). This preferred direction is important due to the high volume of fines (e.g. dust) present during the charging process. If the camera 46 is oriented opposite to that explained above, the image 70 may be degraded due to the presence of such fines. This above-described orientation is thus likely dependent upon knowledge of the direction of travel of the chute 28, and it will be appreciated that the camera 46 can be adjusted to suit any particular arrangement.

The system 10 is arranged, preferably whilst the furnace 10 is inactive, in order to perform a calibration operation to determine a set of furnace parameters corresponding to the particular furnace. The calibration will be explained more fully below. The furnace parameters typically pertain to the behaviour of the charging equipment 22 while charging different materials at different chute angles (ring positions). Values indicative of these behaviours can then be used to mathematically model material distribution, in order to either predict how material will distribute in a furnace 12 during a charge, or to obtain a particular distribution of charge material by modifying the furnace model and the subsequent charge program that is derived from the model. The outcome of the calibration (e.g. the furnace parameters) may thus be used to modify the furnace model to produce a suitable charge program and can be used to alter the model and charge program to produce a desired charge distribution.

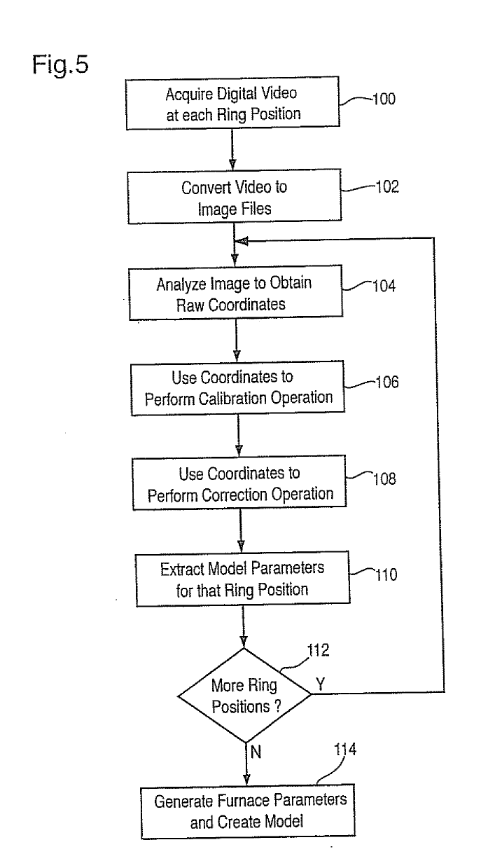

Once the system 10 has been arranged, a calibration procedure for obtaining furnace parameters is shown in FIG. 5, which includes acquiring and analysing falling curves from video footage and still images extracted from the video. One or more digital videos of the falling charge are acquired at step 100 for each ring position. The videos are preferably of the format characterized above, in which case the mpeg files are converted to an AVI format using a suitable conversion program stored in module 54 at step 102. Once the video file has been acquired (and if necessary converted to a particular format), the video file is then converted to a series of consecutive still images using a software module (also stored in module 54) such as the program known as “Virtual Dub”, also at step 102. In this example, the video is converted to AVI since the Virtual Dub program cannot directly read mpeg format. Therefore, it can be seen that any necessary conversion steps are taken at step 102 using module 54, in order to acquire a series of consecutive still images from the raw video data.

Preferably, each video file captures the operation of the chute 28 (charging) at a particular ring position, and obtains footage of the chute 28 passing through the FOV 40 a certain number of times, e.g. four (4). The greater the number of passes through the FOV 40, the greater the chance that the desired orientation of the chute 28 in the image 70 (as explained above) may be obtained in at least one still image. The frames corresponding to those instances when the chute 28 is at the desired position are extracted from the video using analysis module 56 (during step 102) in an image format such as a bitmap (.bmp). In a typical acquisition, approximately forty (40) bitmaps are obtained for each pass to ensure that the most suitable frames are available for analysis.

In practice, it has been found that on the order of 85 video files were sufficient to obtain the desired data when charging coke. Each video contains approximately 3-4 passes, and, for each ring position, there are approximately 4-5 videos (totalling 12-20 passes) of which it was found 3 passes were sufficient to obtain a suitable average. Preferably, each pass used to make the averages should be taken from different videos to increase the chance of capturing variances in the acquisition process, however, the best images typically take precedence, e.g. those having the best illumination, camera orientation, least dust and proper rotation of the chute within the video.

Since coke and other materials such as iron fall differently from the chute 28, they must be imaged separately to extract model parameters for each material. Therefore, the procedure described herein is repeated for each type of material that may be used in the charging program for the furnace 12.

The images that are obtained from the video at step 202 are then analyzed at step 104 in order to obtain the raw coordinates of the image, using module 56. Preferably, one image 70 is selected for each ring position, and each of these images are analyzed in turn. The module 56 may include smart camera software such as Intellect™ by DVT Inc. or other suitable software compatible with computer 50. At step 104, the first image 70 is analyzed using image analysis software 56 to detect the edges 31, 33 of the stream 30a by utilizing an edge detection scheme, e.g. by detecting the highest gradient in contrast. Several stages of filtering may then be applied by module 56 in order to improve the accuracy and quality of the image 70.

For example, pre-filtering may be performed to improve the contrast used for the edge detection, i.e. to provide a sharper image for edge detection. Various other filters may be applied in the following order. Image Domain Gain Filter and then a Noise Reduction Median Filter. The image domain gain, is generally a Laplacian filter, and the noise reduction filter is generally used to reduce the speckle noise produced during a Laplacian filter, as well as spot noise that may be created through any of the acquisition or video conversion stages discussed above. In some cases, the image may be grainy or have a low contrast. In such cases, a gradient filter (e.g. Full, Kirchi, or High Pass) may be implemented prior to the gain filter. The gradient filter generally binarizes the image and helps to identify edges at a cost of a loss in some pixel information.

Once the image analysis program 56 has detected the inner edge 31 and outer edge 33, the other data points representing the stream between the edges 31 and 33 may be interpolated from the values representing the edges 31 and 33. From these measurements, pixel values corresponding to the chute 28a and charge 30a are obtained, using the bottom corner 35 of the chute 28a as the origin (0,0). The corner 35 is designated as the origin, since the raw data should ultimately be in relation to the rotation point of the chute 28, and the distance between the corner 35 and the rotation point is a known value based on the dimensions of the chute 28. The rotation point itself is not used as the origin since it is likely never to be included in the image 70.

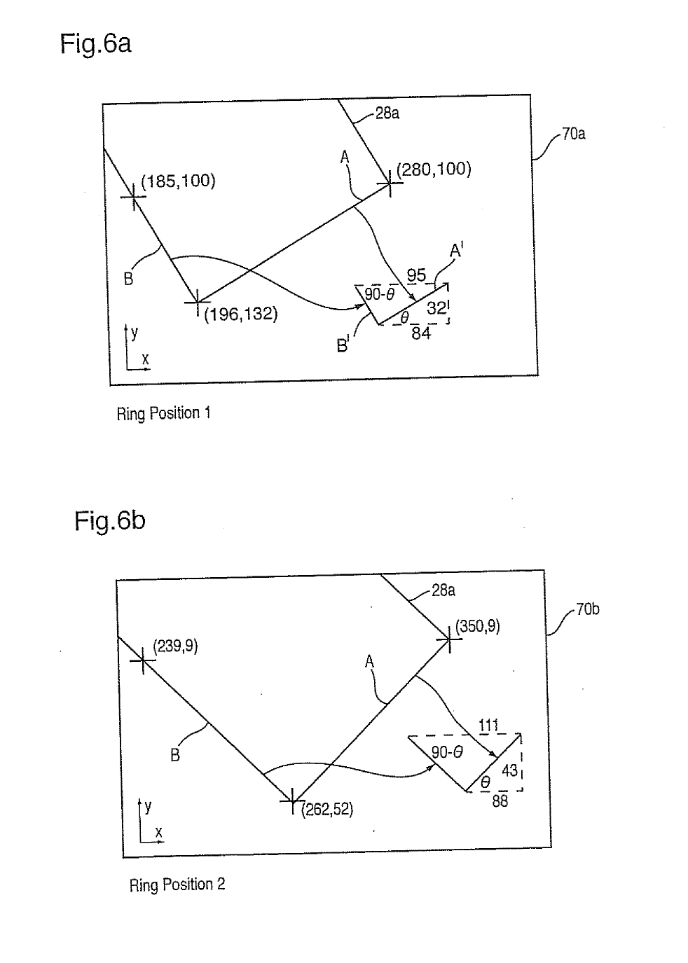

Using objects in the FOV 40, preferably a datum such as an edge A of the chute 28, pixel values can be calibrated at step 106 to real world distance as shown in FIG. 6 using program 58. The real world distances for chute dimensions such as edge A are preferably pre-determined and stored by the computer system 36 as inputs to the following calibration procedure. FIG. 6 illustrates a calibration measurement for each of two different ring positions, denoted ring position 1 in image 70a and ring position 2 in image 70b. To exemplify the calibration measurement, we to position 2 (image 70b). Three points are marked on image 70b, namely the two endpoints defining edge A of the chute 28, and a point along edge B of the chute 28 having the same y-coordinate as the rightmost corner of edge A. The three chosen points in image 70b, are (239,9), (350,9) and (262,52), with respect to the origin (0,0) located at the upper leftmost corner of image 70b. From these points, using standard trigonometry, the angle θ, which is the angle between edge A and the x-axis, is calculated using the pixel coordinates (262,52) and (350,9) FIG. 6. Therefore,

$$tan θ = \frac{43 pixels}{88 pixels} , \\ and θ = 26.04 ° .$$

Using θ, and the physical dimension for edge A stored by computer system 36 being, e.g., equal to 76 cm, a horizontal reference distance (x-direction) and a vertical reference distance (y-direction) may be calculated. Along the x-direction between points (239,9) and (350,9), the horizontal reference is calculated as

$${x}_{ref} = \frac{76 cm}{sin ( 90 - θ )} = 84.5879 cm .$$

Similarly, along the y-direction between either point (239,9) or (350,9) and point (262,52), the vertical reference is calculated as y_{ref}=76 cm×sin θ=33.3661 cm.

Using the horizontal and vertical references, horizontal and vertical conversion factors may be calculated. The distance x_{ref} corresponds to 111 pixels 70b. Therefore, the horizontal conversion factor is calculated as

$${x}_{con} = \frac{84.5879 cm}{111 pixels} = 0.7621 cm \text{/} pixel$$

The distance y_{ref} corresponds to 43 pixels in image 70b. Therefore, the vertical conversion factor is calculated as

$${y}_{con} = \frac{33.3661 cm}{43 pixels} = 0.7660 cm \text{/} pixel .$$

The conversion factors x_{con} and y_{con} are used to measure the trajectory of the charge 30a as it would appear in the particular image (in this case as it would appear in image 70b) based on pixel measurements that are then converted to real world measurements.

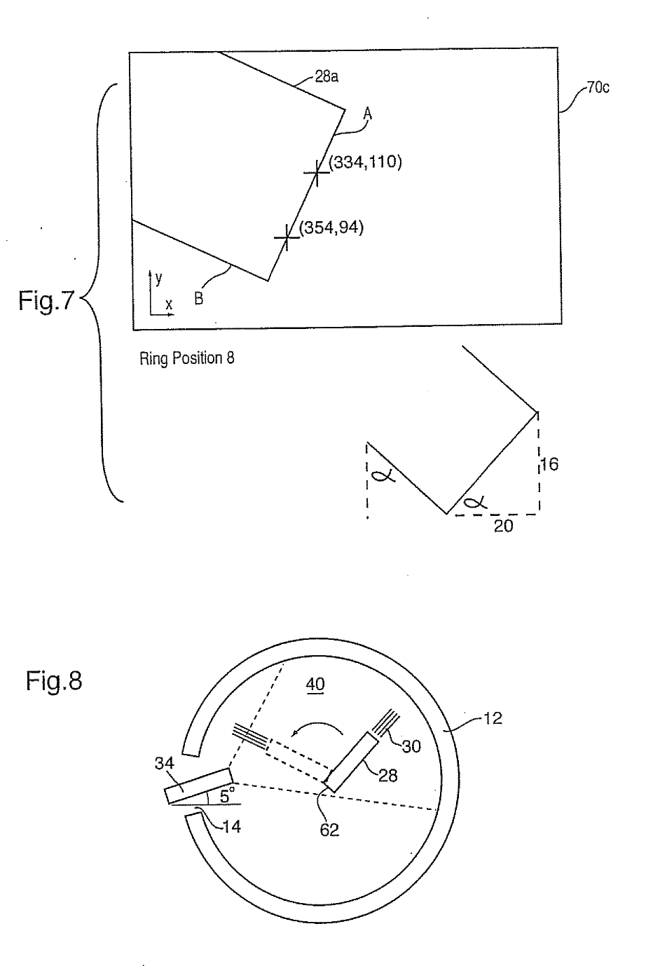

Once the pixel-to-distance calibration has been completed, the coordinates of the acquired image 70 are used to perform a rotation correction operation at step 108 using program 58. FIG. 7 shows 70c at an arbitrarily chosen ring position 8. The rotation correction is performed by determining the angle of inclination of the chute 28a as it is seen in the image 70c, and comparing that to the physical angle of inclination of the chute 28. The physical angle of the chute 28 would preferably be stored as an input by the computer system 36 by detecting the ring position and knowing the corresponding chute angle. The angle may be measured by the calibration program 58 by selecting two points along edge A, e.g., (334,110) and (354,94) as shown in FIG. 7, and determining the horizontal (x-direction) and vertical (y-direction) pixel measurements. Then, the angle of inclination α may be calculated as

$$tan α = \frac{16}{20} , α = 38.66 ° .$$

If the physical angle of inclination were, e.g., 42.8°, then the connection factor is 42.8°−38.66°=4.13°=0.07 radians. This rotation correction can be used to correct for distortion such as skew in the image 70c, to enable more accurate analysis.

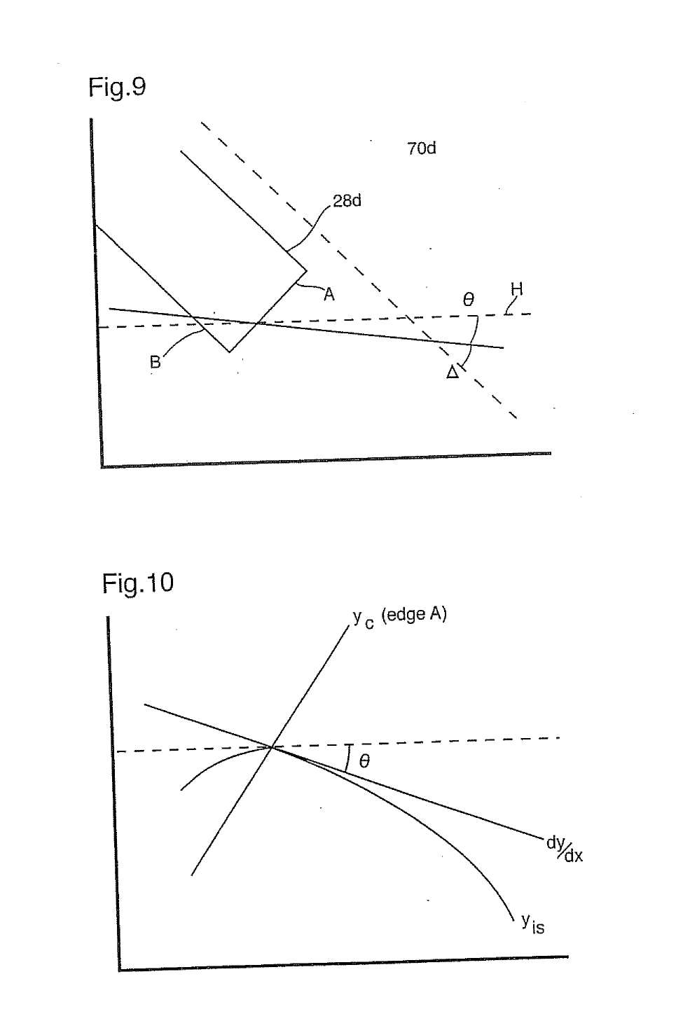

Once the rotation correction is complete, model parameters for that particular ring position are extracted at step 10 using modelling program 60. The model parameters may subsequently be used to calibrate the model as will be explained below. In general, the information required from the image 70 for generating the model for the particular furnace 12, are velocity and delta. The velocity is the speed of the material in the stream at a point closest to the chute 28. The direction (or vector) of this velocity is referenced in relation to the bottom edge of the chute 28. The delta is the angle between the velocity vector and the bottom edge of the chute as shown in FIG. 9.

Referring therefore to FIG. 9, assuming that the solid line is the tangent to the material stream curve where the stream meets the chute 28d, then delta Δ is the angle between the solid line, and a line parallel to edge B of the chute 28d. The angle between the horizontal H and the line parallel to edge B should be known (based on the position of chute 28d), therefore, theta θ (angle between the horizontal H and the solid line) can be determined from the image data and then delta Δ determined therefrom.

Typically delta and velocity are governed by certain formulas. These formulas can be used to tabulate lists of velocities and angles for each ring position, which can be input into the furnace control model, which will use the values to adjust the furnace parameters. The furnace parameters generally include material flow, chute angle, etc.

Preferably, velocity and delta are calculated for the curves representing the inner and outer edges of the stream, as well as a mid-stream curve. For example, making reference to FIGS. 9 and 10, an inner stream represented by curve yᵢₛ can be used to determine a first velocity vector dy/dx. The curve yᵢₛ and curve y_{c} (representing edge A) are equated in order to determine their intercept xₐ (i.e. by solving for yᵢₛ=y_{c}). The tangent of the inner stream (dy/dx) at the intercept xₐ can then be determined using the above curves and xₐ itself.

Using knowledge of the angle of chute 28d theta θ can be determined, and from θ, delta Δ can be calculated. These steps are repeated for the outer stream and middle stream(s) as necessary. These calculations may then be tabulated (with others from different ring positions) and thereafter used to generate furnace parameters which may then be used to derive and/or calibrate a furnace model.

A determination is made at step 112 as to whether or not there are any more ring positions to analyze If yes, steps 104-110 are repeated for the next image, at the next ring position. Once an analysis has been conducted for each ring position, furnace parameters are then generated and stored at step 114, using modelling program 60. Such furnace parameters will correspond to the particular furnace (e.g. furnace 12) and the particular material being charged at that time. This entire process is repeated for each type of charge material that may be used in a charge program, e.g coke, iron, etc. Therefore, the system 10 will acquire video footage, extract images, calculates model parameters for each material type, at each ring position for the particular furnace 12, and produce a complete set of furnace parameters for that furnace with each type of charge material. The furnace parameters may then be used by the modelling program 60 to calibrate the furnace model and generate a custom charge program using the calibrated model, as will be explained more fully below.

The above calibration shown in FIG. 5 therefore produces a set of furnace parameters that may be used for subsequent modelling, particularly for generating a charge program for furnace 12. The charge program can be devised to suit a desired distribution, or may be altered based on the nature of the furnace parameters.

In general, the furnace model is any suitable mathematical model used to represent a relationship between the material being charged, and the resulting distribution within the furnace 12. The model may be adjusted to suit a specific furnace and the different types of material charged based on the furnace parameters generated at step 114. The relationship is built from the tabulated values for velocity and delta that are determined at each ring position, and the model can be adapted to suit any permutation of furnace and material type. It will be appreciated that the furnace model will vary from furnace to furnace and based on the equipment used and the throughput of the charging equipment. The model will also vary depending on the type of top used (e.g. two-bell, bell-less etc.)

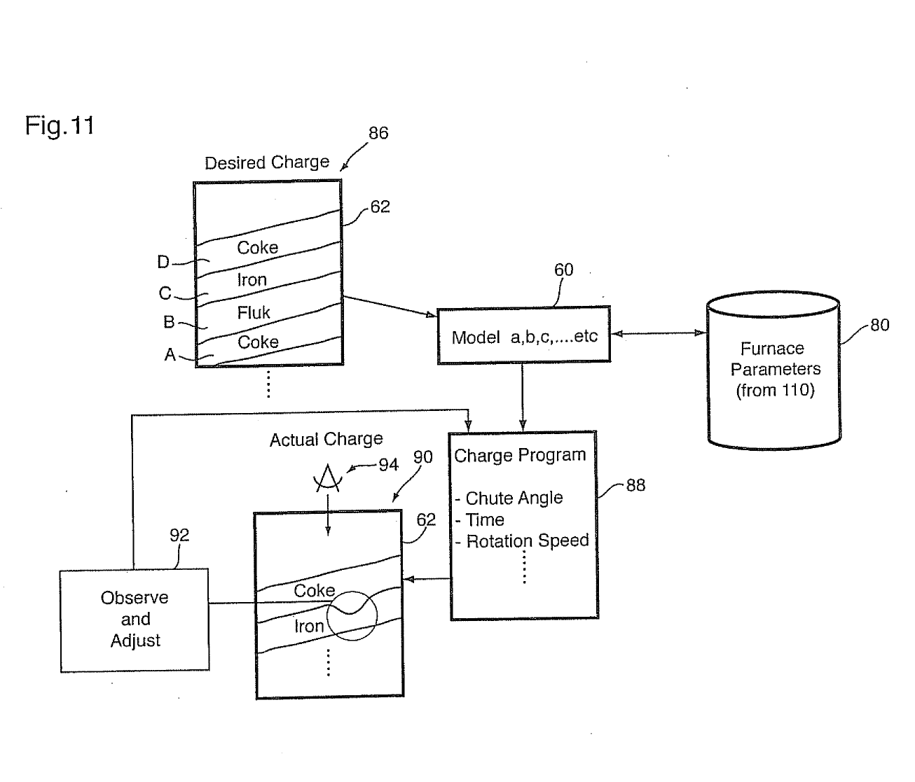

Referring to FIG. 11, the furnace parameters for furnace 12 then may be generated at step 114 are stored in a suitable memory or data store 80. The modelling program 60 is provided with a desired charge profile 86, and then extracts specific furnace parameters for the particular material at the particular layer in the profile. The modelling program 60 may then adapt the furnace model and build a charge program 88 to suit same. For example, the charge program 88 will extract parameters for layer. A, followed by layer B followed by layer C and then by layer D etc. At each layer, the furnace parameters corresponding to the material type (e.g. coke in layer A) are selected and the profile itself analysed to determine, e.g., variations in chute angle (e.g. ring position) and the necessary time for maintaining the chute 28 at ring position needed to achieve the profile, based on the corresponding velocity and delta measurements. The charge program 88 considers such parameters in addition to the ordered sequence of the desired layering in the desired profile 86.

Based on the availability of the previously generated furnace parameters, the modelling program 60 is thus able to dynamically change the model based on the desired charge and its desired distribution, and dictate the sequence of steps in the charge program 88 and the nature of each step.

Preferably, a representation of the actual charge 90 is acquired using a suitable means denoted by numeral 94, such as a vision system or thermal sensor. The actual charge can be used as a feedback to dynamically update the charge program to account for discrepancies between the desired charge 86 and the actual charge 90 during the charging process. This is typically determined manually by observing the representation 92 but may also be done automatically using a suitable software program that can interpret such discrepancies and alter the charge program accordingly. It will be appreciated that the memory 80 will preferably store data for all material types, furnaces, and ring positions so that the modelling program 60 may be used to generate a charge program 88 for any furnace 12 that has undergone the steps outlined in FIG. 5.

Therefore, it may be seen that by acquiring video footage of a charging process, and using the video footage to obtain images showing the trajectory of charge 30 as it falls from the chute 28, blast furnace parameters can be modelled and used to calibrate the charging process. The system 10 can be used during any downtime for the furnace 12 to generate the furnace parameters, and when stored, the furnace parameters can be used to calibrate and adjust the charging program dynamically as needed.

It will be appreciated that although the above examples are described in the context of a blast furnace 12, the system 10 may be used to determine the trajectory of charge material that is distributed into any type of vessel or kiln.

Although the invention has been described with reference to certain specific embodiments, various modifications thereof will be apparent to those skilled in the art without departing from the spirit and scope of the invention as outlined in the claims appended hereto.

What is claimed is:

1. A method for calibrating a model representing the distribution of material into a vessel, said method comprising the steps of acquiring an image of said material at a predetermined distribution position; determining a correlation between a pixel in said image and a unit of distance from an object in said image having a known dimension; determining from said image, a portion thereof representing said material; and using said correlation and said portion to obtain at least one parameter indicative of the nature of said distribution for calibrating said model.

2. A method according to claim 1 wherein acquiring said image includes the steps of obtaining a video of said material as it is distributed in said vessel; and obtaining said image at said predetermined distribution position from said video.

3. A method according to claim 1 further comprising the step of determining a rotational correction factor for use in measuring said trajectory.

4. A method according to claim 1 wherein said steps are repeated a plurality of times for each of a plurality of predetermined distribution positions.

5. A method according to claim 4 wherein said predetermined distribution positions correspond to the angle at which said material is fed into said vessel.

6. A method according to claim 4 comprising acquiring a video of said material as it is distributed into said vessel for each of said predetermined distribution positions and obtaining at least one image from each video.

7. A method according to claim 1 wherein said step of determining a correlation comprises determining a datum in said image for calculating said known dimension relative to said datum; and calculating horizontal and vertical factors representing said correlation using said datum.

8. A method according to claim 7 comprising determining a pair of known dimensions with respect to said datum and measuring an angle between said pair of known dimensions used to calculate said horizontal and vertical factors.

9. A method according to claim 1 wherein said at least one parameter comprises a velocity vector and an angle material measured with respect to said object.

10. A method according to claim 1 farther comprising calibrating said model; creating a charge program according to said at least one parameter to control said distribution; and providing a feedback indicative of current distribution to further calibrate said model during said charge program.

11. A computer program product comprising computer readable instructions for performing the method of claim 1.

12. A system for calibrating a model representing the distribution of material into a vessel, said system comprising: an imaging system for acquiring an image said charge material at a predetermined distribution position; a light source to illuminate said charge material for obtaining said image; a processor in communication with said imaging system for determining a correlation between a pixel in said image and a unit of distance from an object in said image having a known dimension and for determining from said image a portion thereof representing said material and using said correlation and said portion to obtain at least one parameter indicative of the nature of said distribution; and an output comprising said at least one parameter, wherein said output may be used to calibrate said model.

13. A system according to claim 12 further comprising an adjustment mechanism for changing the orientation of said imagine system with respect to said material.

14. A system according to claim 12 further comprising a feedback sensor for determining current distribution to be used to modify a charge program being provided according to said output.

15. A system according to claim 12 wherein said light source is diffuse.

16. A system according to claim 12 wherein said light source is a laser.

17. A system according to claim 12 wherein said imaging system is a digital video recorder or a smart camera.

18. A system according to claim 12 comprising a video conversion module for extracting said image from video acquired using said imaging system.

19. A system according to claim 12 wherein said processor is configured for calibrating said model, creating a charge program according to said output to control said distribution; and providing a feedback indicative of current distribution to further calibrate said model during said charge program.

20. A system according to claim 12 wherein said processor is configured for determining said correlation by determining a datum in said image for calculating said known dimension relative to said datum; determining a pair of known dimensions with respect to said datum; measuring an angle between said pair of known dimensions; and calculating horizontal and vertical factors representing said correlation using said datum.
